(19) United States
(12) Patent Application Publication
(10) Pub. No.: US 2017/0037790 A1
(43) Pub. Date: Feb. 9, 2017

(54) DEVICE FOR CONTROLLING ENGINE AND HYDRAULIC PUMP OF CONSTRUCTION EQUIPMENT AND CONTROL METHOD THEREFOR

(71) Applicants: Dong-Soo KIM, Changwon-si (KR); Sang-Hee LEE, Gimhae-si (KR); VOLVO CONSTRUCTION EQUIPMENT AB, Eskilstuna (SE)

(72) Inventors: Dong-Soo KIM, Changwon-si (KR); Sang-Hee LEE, Gimhae-si (KR)

(73) Assignees: VOLVO CONSTRUCTION EQUIPMENT AB, Eskilstuna (SE); VOLVO CONSTRUCTION EQUIPMENT AB, Eskilstuna (SE)

(21) Appl. No.: 15/304,000

(22) PCT Filed: Apr. 15, 2014
(86) PCT No.: PCT/KR2014/003266

§ 371 Date: Oct. 13, 2016

(51) Int. Cl. F02D 29/04; F02D 41/04; E02F 9/22; F04B 1/29; F04B 1/14; F02D 41/30; F04B 49/06

(52) U.S. Cl. CPC F02D 29/04; F02D 41/3005; F02D 41/04; F04B 49/06; F04B 1/295; F04B 1/146; E02F 9/2296; E02F 9/2235; E02F 9/2246

(57) ABSTRACT

Disclosed are: a device for controlling an engine and a hydraulic pump of construction equipment, capable of increasing fuel efficiency by controlling an engine speed and a hydraulic pump discharge flow rate according to the load of a work device; and a control method therefor. The device for controlling the engine and a hydraulic pump of construction equipment, according to the present invention, comprises: a fuel efficiency selection mode means; an engine RPM control means; a hydraulic pump control means; a work device operation sensing means; and a controller having a first control mode such that in the case of selecting the fuel saving mode, the engine RPM is outputted at the RPM lower than that of the general mode while a swash plate swivel angle of the hydraulic pump is increased corresponding to the operation amount of the operation lever, and in the case of the swash plate swivel angle of the hydraulic pump reaching the maximum angle, the engine RPM is increased so as to discharge the flow rate corresponding to the operation amount of the operation lever.

### TECHNICAL FIELD

The present invention relates to a device for controlling an engine and a hydraulic pump of construction equipment and a control method therefor, and more particularly, a device for controlling an engine and a hydraulic pump of construction equipment and a control method therefor that can improve the fuel efficiency by controlling an engine RPM and a discharge flow rate of a hydraulic pump depending on the work device load.

### BACKGROUND OF THE INVENTION

When the work volume is the primary concern of the work of a hydraulic pump, an engine RPM is increased to the level of an output power of a hydraulic pump that allows the maximum input torque, and, even when the input torque of a hydraulic pump is lowered at the low load, the sufficient discharge flow rate can be sustained by the engine RPM.

The work volume at the high load is limited by the predetermined power corresponding to the load, in which an engine RPM is operated in the relatively high range. Thus, when the input torque of a hydraulic pump comes in the relatively low range, the problem of increasing the fuel consumption of the engine occurs.

On the other hand, there has been the method provided for improving the fuel consumption with the output power of the hydraulic pump kept unchanged by decreasing the engine RPM as well as increasing the input torque of the pump. However, it has the disadvantage of reducing the work speed since the maximum discharge flow rate of a hydraulic pump is restricted by an engine RPM at the low load.

Since the maximum output power of the engine that drives a hydraulic pump is limitedly set, the maximum driving torque of the hydraulic pump is restricted to below the maximum torque of the engine. Also, there has been provided a means of selecting the engine control mode by which an engine RPM and an input torque of a hydraulic pump are set in order to control the work speed depending on the work condition. As shown in FIG. 1, in the case of the low load work (pressure is below A), a main control valve (MCV) is switched to the maximum so that the flow rate of a hydraulic pump is discharged in proportion to the maximum displacement rate of a hydraulic pump associated with the engine RPM. On the contrary, as shown in the case of the high load work of FIG. 1, the pressure generated on the work device increases, and thus the maximum discharge flow rate decreases gradually, which result in the reduction of the work device speed.

### SUMMARY OF THE INVENTION

Accordingly, the present invention has been made to solve the aforementioned problems occurring in the related art, and it is an objective of the present invention to provide a device for controlling an engine and a hydraulic pump of construction equipment and a control method therefor which, by selecting a fuel saving mode, makes it possible to achieve with the improved fuel efficiency the speed and power of the work device at the same level as those in a general mode.

### Technical Solution

According to an embodiment of the present invention to achieve the above-described objective, there is provided a device for controlling an engine and a hydraulic pump of construction equipment comprising;

a fuel efficiency selection mode means for selecting either a fuel saving mode or a general mode,

an engine RPM control means for controlling the engine RPM,

a hydraulic pump control means for controlling the displacement rate of the hydraulic pump by controlling a swash plate swivel angle of the hydraulic pump,

a work device operation sensing means for sensing an operation amount of an operation lever in order to operate the work device, and

a controller having a first control mode wherein, in the case of selecting the fuel saving mode, the engine RPM is outputted at the RPM lower than that of the general mode while the swash plate swivel angle of the hydraulic pump is increased corresponding to the operation amount of the operation lever, and in the case of the swash plate swivel angle of the hydraulic pump reaching the maximum angle, the engine RPM is increased so as to discharge the flow rate corresponding to the operation amount of the operation lever.

According to an embodiment of the present invention, a method for controlling an engine and a hydraulic pump of construction equipment comprising;

selecting either a fuel saving mode or a general mode by a fuel efficiency selection mode means,

inputting a first and a second engine RPMs having the magnitudes different from each other, in the case of selecting the fuel saving mode,

calculating and the displacement rate of the hydraulic pump based on a flow rate required for the operation amount of the operation lever and the lower engine RPM between the first engine RPM and the second engine RPM,

calculating the required power of the hydraulic pump based on the higher engine RPM between the first engine RPM and the second engine RPM, in the case that the calculated displacement rate of the hydraulic pump is same as the predetermined maximum value, and

restricting both the engine RPM and the displacement rate of the hydraulic pump, in the case that the calculated power required for the hydraulic pump is higher than the predetermined maximum value.

More preferably, the controller includes a second control mode such that in the case of the general mode, the displacement rate of the hydraulic pump is calculated in order to discharge the flow rate corresponding to the operation amount of the operation lever, and the calculated displacement rate is applied to the driving unit of the hydraulic pump.

The controller calculates the required power of the hydraulic pump by taking into account the flow rate corresponding to the operation amount of the operation lever as well as the hydraulic pump pressure sensed by a sensing means configured on the upper side of the supply path of the hydraulic pump, and includes a third control mode which is, in the case of the fuel saving mode, outputting the engine RPM and the displacement rate that are restricted so that the calculated power required for the hydraulic pump is restricted to the predetermined value.

The controller includes a fourth control mode which is, in the case of general mode, outputting the displacement rate that is restricted.

The engine RPM in the third control mode is restricted to be lower than that in the fourth mode.

The controller further includes a step of calculating, in case of general mode, the displacement rate of the hydraulic pump by taking into account the engine RPM higher between the first engine RPM and the second engine RPM as well as the flow rate corresponding to the operation amount of the operation lever, and a step of restricting the displacement rate of the hydraulic pump if the calculated power required for the hydraulic pump is higher than the predetermined maximum value when the calculation is made using the higher engine RPM between the first engine RPM and the second engine RPM.

### Advantageous Effect

According to the present invention having the above-described elements, the reliability is increased with the improved fuel efficiency while the speed and power of the work device in a fuel saving mode are kept at the same level as those in a general mode.

### BRIEF DESCRIPTION OF THE DRAWINGS

FIG. 1 represents the line of the maximum torque of the variable capacity hydraulic pump.

FIG. 2 shows the engine operation point and the comparison line of the fuel efficiency under the high load in a device for controlling an engine and a hydraulic pump of construction equipment according to an embodiment of the present invention.

FIG. 3 is the graph illustrating the fuel saving mode in a device for controlling an engine and a hydraulic pump of construction equipment according to an embodiment of the present invention.

FIG. 4 is the graph illustrating the engine operation point and the comparison line of the fuel efficiency under the low load in a device for controlling an engine and a hydraulic pump of construction equipment according to an embodiment of the present invention.

FIG. 5 is the flow chart of a method for controlling an engine and a hydraulic pump of construction equipment according to an embodiment of the present invention.

FIG. 6 is the drawing representing the controller configuration of a device for controlling an engine and a hydraulic pump of construction equipment according to an embodiment of the present invention.

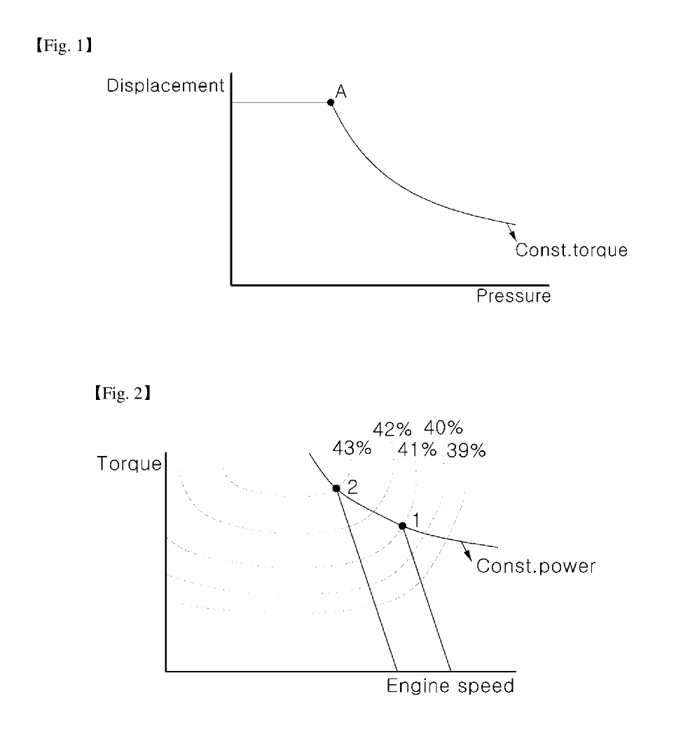

### EXPLANATION OF REFERENCE NUMERALS FOR MAIN PARTS IN THE DRAWING

10: fuel efficiency mode selection means
20: engine RPM control means
30: hydraulic pump control means
40: work device operation sensing means
50: controller
60: hydraulic pump pressure sensing means

### DETAILED DESCRIPTION OF THE INVENTION

Hereinafter, a device for controlling an engine and a hydraulic pump of construction equipment and a method therefor according to a preferred embodiment of the present invention will be described in detail with reference to the accompanying drawings.

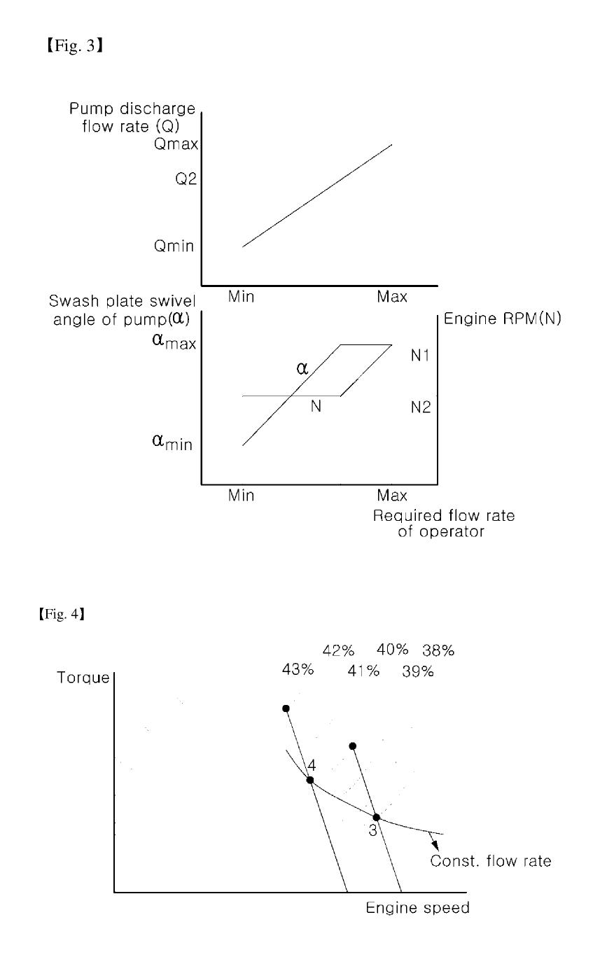

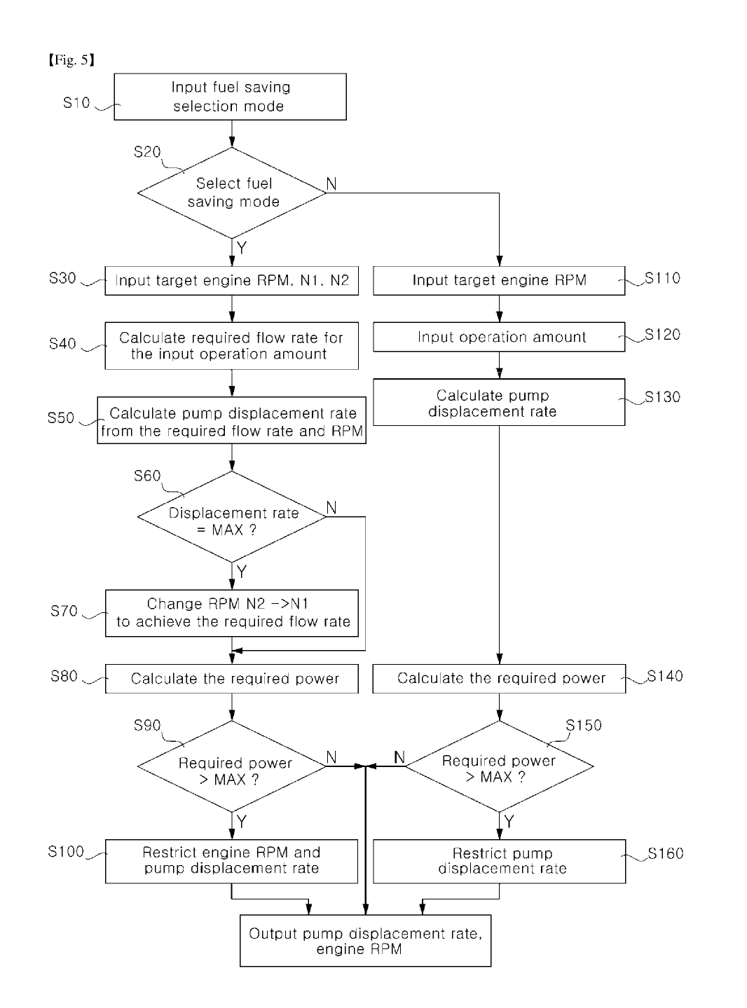

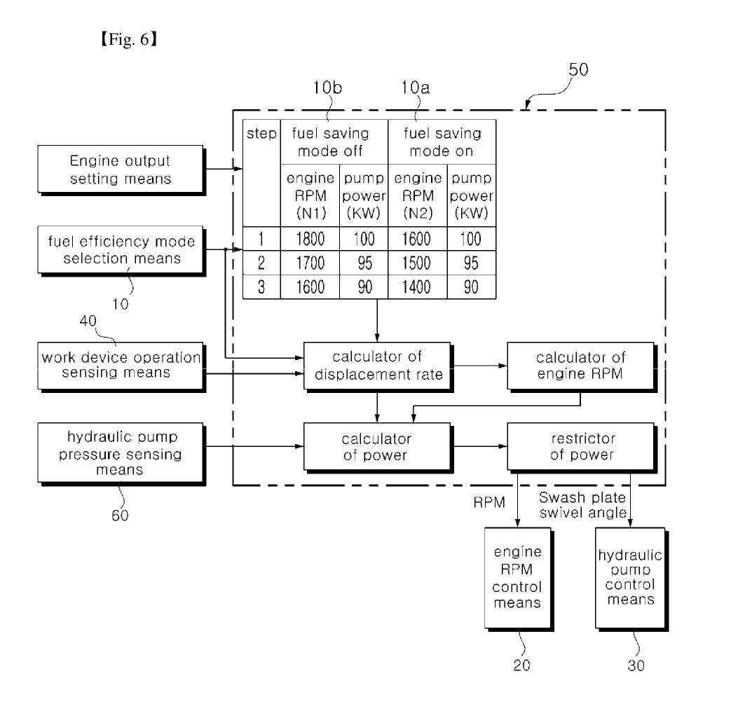

FIG. 2 shows the engine operation point and the comparison line of the fuel efficiency under the high load in a device for controlling an engine and a hydraulic pump of construction equipment according to an embodiment of the present invention, FIG. 3 is the graph illustrating the fuel saving mode in a device for controlling an engine and a hydraulic pump of construction equipment according to an embodiment of the present invention, FIG. 4 is the graph illustrating the engine operation point and the comparison line of the fuel efficiency under the low load in a device for controlling an engine and a hydraulic pump of construction equipment according to an embodiment of the present invention, FIG. 5 is the flow chart of a method for controlling an engine and a hydraulic pump of construction equipment according to an embodiment of the present invention, and FIG. 6 is the drawing representing the controller configuration of a device for controlling an engine and a hydraulic pump of construction equipment according to an embodiment of the present invention.

With reference to FIG. 5 and FIG. 6, a device for controlling an engine and a hydraulic pump of construction equipment according to an embodiment of the present invention has a variable capacity hydraulic pump operated by the engine and a work device operated by an operation oil of the hydraulic pump, comprising;

a fuel efficiency selection mode means (10) for selecting either a fuel saving mode (10a) or a general mode (10b),

an engine RPM control means (20) for controlling the engine RPM,

a hydraulic pump control means (30) for controlling the displacement rate of the hydraulic pump by controlling a swash plate swivel angle of the hydraulic pump,

a work device operation sensing means (40) for sensing an operation amount of an operation lever (RCV) in order to operate the work device, and

a controller (50) having a first control mode wherein, in the case of selecting the fuel saving mode (10a), the engine RPM is outputted at the RPM lower than that of the general mode (10b) while the swash plate swivel angle of the hydraulic pump is increased corresponding to the operation amount of the operation lever, and in the case of the swash plate swivel angle of the hydraulic pump reaching the maximum angle, the engine RPM is increased so as to discharge the flow rate corresponding to the operation amount of the operation lever.

The controller (50) may include a second control mode such that in the case of the general mode (10b), the engine RPM is outputted at the RPM higher than that of the fuel reduction mode (10a), the displacement rate of the hydraulic pump is calculated in order to discharge the flow rate corresponding to the operation amount of the operation lever, and the calculated displacement rate is applied to the driving unit of the hydraulic pump.

The controller (50) may include a third control mode that calculates the required power of the hydraulic pump by taking into account the flow rate corresponding to the operation amount of the operation lever as well as the hydraulic pump pressure sensed by the sensing means (60) configured on the upper side of the supply path of the hydraulic pump, and in the case of the fuel saving mode (10a), is outputting the engine RPM and the displacement rate that are restricted so that the calculated power required for the hydraulic pump is restricted to the predetermined value.

The controller (50) may include a fourth control mode which is, in case of general mode (10b), outputting the displacement rate that is restricted.

The engine RPM in the third control mode may be restricted to be lower than that in the fourth mode.

With reference to FIG. 5, a method for controlling an engine and a hydraulic pump of construction equipment according to an embodiment of the present invention comprises;

a step (S10) of inputting a fuel saving mode in order to the fuel efficiency,

a step (S20) of selecting either the fuel saving mode (10a) or the general mode (10b) by the fuel efficiency selection mode means (10),

a step (S30) of inputting a first and a second engine RPMs (N1, N2) having the magnitudes different from each other, in the case of selecting the fuel saving mode (10a),

a step (S40) of calculating a flow rate required for the operation amount of the work device,

a step (S50) of calculating the displacement rate of the hydraulic pump based on the flow rate required for the operation amount of the work device and the lower engine RPM (e.g. N2) between the first engine RPM and the second engine RPM (N1, N2),

a step (S60) of determining if the calculated displacement rate of the hydraulic pump is same as the predetermined maximum value,

a step (S70) of replacing the lower engine RPM (N2) with the higher engine RPM (N1) to ensure the required flow rate of the hydraulic pump, in the case that the calculated displacement rate of the hydraulic pump is same as the predetermined maximum value,

a step (S80) of calculating the required power of the hydraulic pump based on the higher engine RPM (N1)

a step (S90) of comparing the required power calculated in (S80) with the predetermined maximum value,

a step (S100) of restricting both the engine RPM and the displacement rate of the hydraulic pump, in the case that the calculated power required for the the hydraulic pump is higher than the predetermined maximum value.

a step (S110) of inputting and the higher engine RPM (N1) between the first engine RPM and the second engine RPM, in the case of selecting the general mode (10b),

a step (S120) of inputting the operation amount of the work device,

a step (S130) of calculating the displacement rate of the hydraulic pump based on the flow rate required corresponding to the operation amount of the work device,

a step (S140) of calculating the required power of the hydraulic pump based on the higher engine RPM (N1) between the first engine RPM and the second engine RPM,

a step (S150) of comparing the calculated required power with the predetermined maximum value, and

a step (S160) of restricting the displacement rate of the hydraulic pump, in the case that the calculated required power is higher than the predetermined maximum value.

In order to save the fuel and improve the fuel efficiency, the selection mode is inputted as described in S10.

As in S20, it proceeds with S30 when the fuel saving mode (10a) is selected by the fuel efficiency mode selection means (10). On the other hand, it proceeds with S110 when the general mode (10b) is selected by the fuel efficiency mode selection means (10).

As in S30, when the fuel saving mode (10a) is selected, the relatively low second RPM (N2) is inputted. For example, the second engine RPM (N2) is 1600 (high speed), 1500 (medium speed), or 1400 (low speed).

As in S40, the flow rate of the hydraulic pump required corresponding to the operation amount of the work device is calculated.

As in S50, the displacement rate of the hydraulic pump is calculated based on the flow rate required for the operation amount of the work device and the lower engine RPM (N2) between the first engine RPM and the second engine RPM (N1, N2).

As in S60, it determines if the calculated displacement rate of the hydraulic pump is same as the predetermined maximum value, and it proceeds with S70 when the calculated displacement rate of the hydraulic pump is same as the predetermined maximum value. If the calculated displacement rate of the hydraulic pump is not same as the predetermined maximum value, it proceeds with S80.

As in S70, when the calculated displacement rate of the hydraulic pump is same as the predetermined maximum value, the lower engine RPM (N2) is replaced with the higher engine RPM (N1) to ensure the required flow rate of the hydraulic pump. (N2->N1)

As in S80, the required power of the hydraulic pump is calculated based on the higher engine RPM (N1).

As in S90, by comparing the required power calculated based on first engine RPM (N1) with the predetermined maximum value, it proceeds with S100 when the required power calculated based on first engine RPM (N1) is higher than the predetermined maximum value, and it ends when the required power calculated based on first engine RPM (N1) is lower than the predetermined maximum value.

As in S100, both the engine RPM and the displacement rate of the hydraulic pump are restricted when the required power calculated based on first engine RPM (N1) is higher than the predetermined maximum value.

On the other hand, as in S20, the general mode (10b) is selected, the relatively high first RPM (N1) is inputted. In this case, the first engine RPM (N1) is 1800 (high speed), 1700 (medium speed), or 1600 (low speed).

As in S120, the flow rate of the hydraulic pump required corresponding to the operation amount of the work device is calculated.

As in S130, the displacement rate of the hydraulic pump is calculated based on the flow rate required for the operation amount of the work device.

As in S140, the required power of the hydraulic pump is calculated based on the higher engine RPM (N1).

As in S150, by comparing the required power calculated based on first engine RPM (N1) with the predetermined maximum value, it proceeds with S160 when the required power calculated based on first engine RPM (N1) is higher than the predetermined maximum value, and it ends when the required power calculated based on first engine RPM (N1) is lower than the predetermined maximum value.

As in S160, the displacement rate of the hydraulic pump is restricted when the required power calculated based on first engine RPM (N1) is higher than the predetermined maximum value.

As shown in FIG. 2, when the hydraulic pump is operated at the maximum input torque of point 1, the fuel efficiency of 41% is achieved in the engine under the high load. On the contrary, when the hydraulic pump is operated at the maximum input torque of point 2, the fuel efficiency of 43% is achieved. (at the same work amount, the fuel efficiency is improved by about 4.7% compared to the setting of point 1). That is, under the low load, the work device speed is expected to decrease as the engine speed is lowered. On the contrary, under the high load, the fuel efficiency is improved since the fuel consumption is reduced with the same work amount.

As shown in FIG. 3, under the condition that the maximum flow rate is obtained by the first engine RPM (N1) in the general mode, when it comes to the fuel saving mode (10a) in which the swash plate swivel angle of the hydraulic pump is adjusted to the angle of second engine RPM (N2) down from that of the first engine RPM (N1), the maximum flow rate of the hydraulic pump is restricted to Q2, causing the problem of lowering the work device speed under the low work load compared with the speed in the general mode (10b).

In this case, the maximum work speed in the general mode (10b) can be obtained by proportionally increasing the engine RPM from the second engine RPM (N2) to the first engine RPM (N1).

It can be seen from FIG. 3 that the displacement rate should be higher in the fuel saving mode (10a) when the engine RPM is adjusted to the second engine RPM (N2). That is, the displacement rate of the hydraulic pump under the low load work is controlled to increase in order to keep the work speed at the same level as that under the same load condition. As shown in FIG. 4, when the input torque of the hydraulic pump is at point 4, the fuel efficiency of the engine becomes 41%.

Although the present invention has been described with reference to the preferred embodiment in the attached figures, it is to be understood that various equivalent modifications and variations of the embodiments can be made by a person having an ordinary skill in the art without departing from the spirit and scope of the present invention as recited in the claims.

### INDUSTRIAL APPLICABILITY

According to the present invention having the above-described configuration, when the fuel saving mode is selected, it brings the effect of improving the fuel efficiency while the speed and power of the work device kept at the same level as those in a general mode.

What is claimed is:

1. A device for controlling an engine and a hydraulic pump of construction equipment comprising;
a fuel efficiency selection mode means for selecting either a fuel saving mode or a general mode,
an engine RPM control means for controlling the engine RPM,
a hydraulic pump control means for controlling the displacement rate of the hydraulic pump by controlling a swash plate swivel angle of the hydraulic pump,
a work device operation sensing means for sensing an operation amount of an operation lever in order to operate a work device, and
a controller having a first control mode wherein, in the case of selecting the fuel saving mode, the engine RPM is outputted at a RPM lower than that of the general mode while the swash plate swivel angle of the hydraulic pump is increased corresponding to the operation amount of the operation lever, and in the case of the swash plate swivel angle of the hydraulic pump reaching the maximum angle, the engine RPM is increased so as to discharge a flow rate corresponding to the operation amount of the operation lever.

2. The device for controlling an engine and a hydraulic pump of construction equipment of claim 1, wherein the controller includes a second control mode such that in the case of the general mode, the displacement rate of the hydraulic pump is calculated in order to discharge the flow rate corresponding to the operation amount of the operation lever, and the calculated displacement rate is applied to a driving unit of the hydraulic pump.

3. The device for controlling an engine and a hydraulic pump of construction equipment of claim 2, wherein the controller includes a third control mode which calculates a required power of the hydraulic pump by taking into account the flow rate corresponding to the operation amount of the operation lever as well as a hydraulic pump pressure sensed by a hydraulic pump pressure sensing means configured on the upper side of the supply path of the hydraulic pump, and is, in the case of the fuel saving mode, outputting the engine RPM and the displacement rate that are restricted so that the calculated power required for the hydraulic pump is restricted to the predetermined value.

4. The device for controlling an engine and a hydraulic pump of construction equipment of claim 3, wherein the controller includes a fourth control mode which is, in the case of general mode, outputting the displacement rate of the hydraulic pump that is restricted.

5. The device for controlling an engine and a hydraulic pump of construction equipment of claim 4, wherein the engine RPM in the third control mode is restricted to be lower than that in the fourth mode.

6. A method for controlling an engine and a hydraulic pump of construction equipment comprising;
selecting either a fuel saving mode or a general mode by a fuel efficiency selection mode means,
inputting a first and a second engine RPMs having the magnitudes different from each other, in the case of selecting the fuel saving mode,
calculating a displacement rate of the hydraulic pump based on a flow rate required for the operation amount of an operation lever and the lower engine RPM between the first engine RPM and the second engine RPM,
calculating a required power of the hydraulic pump based on the higher engine RPM between the first engine RPM and the second engine RPM, in the case that the calculated displacement rate of the hydraulic pump is same as the predetermined maximum value, and
restricting both the engine RPM and the displacement rate of the hydraulic pump, in the case that the calculated power required for the hydraulic pump is higher than the predetermined maximum value.

7. The method for controlling an engine and a hydraulic pump of construction equipment of claim 6 further comprising;
a step of calculating, in the case of the general mode, the displacement rate of the hydraulic pump by taking into account the engine RPM higher between the first engine RPM and the second engine RPM as well as the flow rate corresponding to the operation amount of the operation lever, and
a step of restricting the displacement rate of the hydraulic pump if the calculated power required for the hydraulic pump is higher than the predetermined maximum value when the calculation is made using the higher engine RPM between the first engine RPM and the second engine RPM.
